(19) United States
(12) Patent Application Publication
(10) Pub. No.: US 2009/0157505 A1
(43) Pub. Date: Jun. 18, 2009

(54) Shopping mall system and shopping mall system for temples and shrines

(75) Inventor: Kazuyuki Yokoyama, Nagoya-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Rio Yokoyama Co., Ltd.

(21) Appl. No.: 12/001,569

(22) Filed: Dec. 12, 2007

(51) Int. Cl. G06Q 30/00

(52) U.S. Cl. 705/14

(57) ABSTRACT

A temple/shrine shopping mall system includes a temple or shrine, plural stores, a management center that manages the entire system, and a network connecting these components. The temple or shrine includes Omamori-fudas each including a recording medium that records details of discounts or the number of points when products or services are provided by the stores, an Omamori-fuda vending machine that is installed at the temple or shrine to vend the Omamori-fuda and registers the details of discounts or the number of points in the recording medium, an Omikuji vending machine that vends an Omikuji and registers the details of discounts or the number of points in the recording medium, a saisenbako that includes a reader/writer, and a saisen-token vending machine that vends a saisen token.

### BACKGROUND OF THE INVENTION

1. Field of the Invention

The present invention relates to a shopping mall system, and, more particularly to a shopping mall system in which an event facility and stores are connected through a network, and the number of privilege points granted to a user is increased or decreased according to details of an event in the event facility and usages in the stores.

2. Description of the Related Art

Recently, large-scale shopping malls including many stores have appeared near interchanges on expressways or in sightseeing areas. The location of such shopping mall requires relatively-easy access and a large parking space. It is more preferable that the shopping mall holds appealing events that attract customers, or be attractive as a sightseeing area. It is also required to make the sizes of the stores in the shopping malls relatively large and to treat relatively fine quality products, to differentiate the stores from usual stores. The appeal of the shopping mall is that the number of products is large and various kinds of privileges are granted. For example, foreign brand-name products can be purchased at lower prices than in the usual stores. To implement such privileges, an event site is for example placed around the shopping mall, to attract more visitors. Visitors coming with the aim of the event are targeted for distributing discount coupons offered by the stores that support the event. The same products are sold at higher discount rates to customers having the discount coupons, which raises buying motivations of the customers.

However, even when the event site and the shopping mall are located near, the both usually exist and operate individually and independently from each other. Planning and operations for enhancing the respective utility values is rarely performed in cooperation with each other. That is, the part of the event site is devoted to providing services only to visitors who have come with the aim of the event, and, even when a shopping mall is located near, merely utilizes the shopping mall as means for leading the visitors to the event site. On the other hand, the part of the shopping mall only expects that the visitors gathering in the event site visit the shopping mall in passing after the event has finished, and has little cooperative or usage relationship to actively participate in the event. In many cases, the stores in the shopping mall individually have a Point-of-Sale (POS) system. However, this is merely a system configured using a closed network between a head store and branches. Further, services are effective only in each store, and most of the service systems cannot be commonly used by other stores. Thus, not only the product prices of the shopping mall cannot be discounted according to privileges offered by the event site (for example, discount of the product prices using a point system), but also services common to all the stores cannot be provided. There is no network connecting the event site and the shopping mall, and thus uniform management of information using electronic data cannot be performed.

Many of the conventional shopping malls have been constructed in facilities or sites attracting a large crowd, such as play facilities, hotels, interchanges on expressways, and historic sites (for example, castles) in sightseeing areas, and no shopping mall has been integrally constructed with temples or shrines. It is thought that this is mainly because the temples and shrines are holy places and people feel uncomfortable using the temples and shrines as event facilities. Even when a shopping mall is constructed next to a temple or shrine, the only thing that can be done is to expect that people visiting the temple or shrine come by the shopping mall in passing at will after offering prayers. Thus, actions of the worshippers at the temple or shrine, i.e., offertory (an act of dedicating money called “saisen” to gods or Buddha in thanks for realized wishes) or purchase of an Omamori (having the same meaning of Omamori-fuda; a talisman thought to be imbued with power of gods or Buddha to favor and protect a holder) or an Omikuji (a sacred lot telling fortunes, which is drawn praying to gods or Buddha to consult an oracle) are not treated as events.

Japanese Patent Application Laid-open No. 2002-208070 discloses a privilege-point grant system that grants customers privilege points for urging the customers to continuously and repeatedly come to a store. According to this application, plural receivers that receive radio waves outputted from transmitters that are held by customers to detect identification information stored in the transmitters from the radio waves are installed in plural selling spaces in a store. A data management server detects amounts of actions in the store of the customers coming to the store, based on a result of the detection by the plural receivers, determines privilege points to be granted to each customer by a determining unit, based on the amount of action detected for each customer, and stores an accumulated total of plural privilege points determined by the determining unit for different opportunities of coming to the store of the same customer.

Japanese Patent Application Laid-open No. 2005-85097 discloses a praying system that enables a prayer to promptly obtain an Omamori or an Ofuda (a paper charm provided by a shrine or temple, same as Omamori) of a faraway shrine or temple, and to pray. According to this system, a praying terminal informs a praying server of an Omamori ID and a shrine or temple ID read from an IC chip included in the Omamori, and prayer information and details of a prayer, inputted by the payer. The praying server writes the received prayer information and details of the prayer in a storage unit, related to the Omamori ID and the shrine or temple ID, and informs a shrine or temple server of the shrine or temple specified by the shrine or temple ID. The shrine or temple gives invocation according to the prayer information and the details of the prayer received by the shrine or temple server.

Japanese Patent Application Laid-open No. 2000-60720 discloses a saisen system that can prevent theft of saisen and provides a realistic sensation at praying. This application discloses a saisen system including a saisen-coin vending machine including: a touch panel for inputting information about an amount of saisen; a noncontact communication antenna that receives information about an available amount of money outputted from a noncontact IC card and transmits information about an updated amount of money; a processing controller that outputs a saisen-coin issuance control signal and the information about the updated amount of money when the information about the available amount of money is equal to or higher than the information about the amount of saisen; and a saisen-coin issuing unit that issues a saisen coin based on the saisen-coin issuance control signal, and a saisenbako (offertory box) in which the saisen coin is thrown.

Japanese Patent Application Laid-open NO. 07-289414 discloses a saisenbako that increases psychological effects of worshippers at throwing of saisen in the saisenbako, and facilitates collection of offered saisen according to types of money.

As described above, the conventional shopping mall has such a configuration that the event site and the shopping mall merely exist independently side by side, without any collaboration or close mutual exploitation. Thus, the part of the event site utilizes the shopping mall simply as means for leading the visitors to the event site. The part of the shopping mall only expects that the visitors gathering in the event site incidentally come by the shopping mall in passing, and has little cooperative or usage relationship to actively participate in the event. There has been no case that the event site and the shopping mall integrally configure the shopping mall.

Further, many of the conventional shopping malls have systems configured using a closed network. Accordingly, not only the products in the shopping mall cannot be discounted according to the privileges offered by the event site, but also common services cannot be provided by the respective stores in the shopping mall.

Because no network connecting the event site and the shopping mall is provided, uniform management of information using electronic data cannot be performed.

There is no conventional shopping mall that is constructed integrally with a shrine or temple. Thus, actions of worshippers at the shrine or temple, i.e., actions of offertory and purchase of an Omamori or Omikuji are not treated as events.

The conventional technique disclosed by Japanese Patent Application Laid-open No. 2002-208070 determines the privilege points based on the amounts of actions in the store of customers coming to the store and accumulates the points. The point grant is not always performed to the customers who have purchased products in the store. That is, product purchasers and simple visitors to the store cannot be distinguished.

The conventional technique disclosed in Japanese Patent Application Laid-open No. 2005-85097 determines the type of invocation based on the Omamori ID and the temple or shrine ID read from the IC chip included in the Omamori, and the prayer information and the details of the prayer inputted by the prayer. The prayer needs to input all the information, which is bothersome.

The conventional technique disclosed in Japanese Patent Application Laid-open No. 2000-60720 changes money into a saisen coin at offertory, to prevent theft of the saisen. The worshippers need to purchase saisen coins in each case, which imposes extra burdens to the worshippers.

The conventional technique disclosed in Japanese Patent Application Laid-open No. 07-289414 provides the saisenbako that issues sound effects of offertory, and facilitates collection of thrown saisen according to types of the money. When the saisen is a coin, the discrimination is possible. However, when the saisen is a bill, the discrimination is impossible. In some cases, bills can be jammed in a discriminator.

### SUMMARY OF THE INVENTION

The present invention has been achieved in view of the above problems, and an object of the present invention is to provide a shopping mall system in which an event facility and stores are connected through a network, and control is performed so that the number of privilege points recorded on a recording medium that is held by a customer is increased or decreased according to details of an event at the event facility and details of usage in the stores, so that the event facility and the stores can function integrally.

Another object of the present invention is to provide a temple/shrine shopping mall system in which a temple or shrine is assumed as the event facility, and an Omamori-fuda (a talisman thought to be imbued with power of gods or Buddha to favor and protect its holder) is issued as a recoding medium, and the number of privilege points is increased or decreased according to actions at the temple or shrine, such as offering of saisen (money offered to gods or Buddha in thanks for realized wishes) or purchase of an Omikuji, and according to the details of usage in the store.

To solve the above problems, according to the present invention, a shopping mall system that includes a principal visitor-attracting facility, subordinate visitor-attracting facilities, and a network that connects both of the principal and subordinate visitor-attracting facilities, and promotes visits of visitors to the principal visitor-attracting facility, to the subordinate visitor-attracting facilities includes: a recording medium that records privileges granted to a customer who uses each of the visitor-attracting facilities; a register that registers the number of privilege points in the recording medium based on details of an event implemented in the principal visitor-attracting facility; a reader or reader/writer that is installed at least in either the principal visitor-attracting facility or the subordinate visitor-attracting facilities, to read or write necessary information from or on the recording medium held by a user of the visitor-attracting facility; and a managing unit that manages the shopping mall system based on the number of privilege points on the recording medium, read by the reader or reader/writer through the network, in which the managing unit includes: a determining unit that reads the information recorded on the recording medium using the reader or reader/writer when information of a purchased product and price information of the product is inputted by a POS system, to determine whether the number of privilege points is recorded and whether the purchased product matches a type of the recording medium; and a calculating unit that calculates a discount rate and a charge for the product based on presence or absence of the number of privilege points and presence or absence of the product matching the type of the recording medium, and when the determining unit determines that required number of privilege points is recorded and that the purchased product matches the type of the recording medium, the calculating unit increases the discount rate for the corresponding product and calculates the charge according to the number of the privilege points.

In the system according to the present invention, the principal visitor-attracting facility and the subordinate visitor-attracting facilities are connected by the network, and each of the facilities includes the reader or reader/writer. The managing unit reads the number of privilege points recorded on the recording medium using the reader or reader/writer, and controls the reader or reader/writer to increase or decrease the read number of privilege points according to details of usage in the respective visitor-attracting facilities.

According to the present invention, the recording medium is one of a magnetic card, a contact or noncontact IC card, and an IC tag.

When a magnetic card, a contact or noncontact IC card, or an IC tag is used for the recording medium, the information recorded on the recording medium can be processed as electronic data.

According to the present invention, when personal information recorded on the recording medium is read by the reader or reader/writer and transmitted to the managing unit through the network, the calculating unit changes the details of the event according to the personal information recorded in a database of the managing unit.

The personal information of a customer includes for example the name, the birth date, the sex, and the address, and the like. Therefore, some of the information is necessary or unnecessary depending on the personal information. For example, there is no need to inform male customers of events specific to females about childbirth and the like.

According to the present invention, when personal information recorded on the recording medium is read by the reader or reader/writer and transmitted to the managing unit through the network, the calculating unit changes the number of privilege points according to the personal information recorded in a database of the managing unit.

The school age can be determined from the birth date in the personal information. Accordingly, customers of ages for school entrance can be given service such as increase of discount rates at purchase of stationery and the like even with the same number of privilege points.

According to the present invention, at least the name, the sex, the birth date, and the address of a customer, the type of the recording medium, the number of privilege points, and the details of discounts are recorded on the recording medium.

The personal information includes the name, the sex, the birth date, and the address as required minimum information. According to the present invention, in addition thereto, the number of privilege points to be reflected on discounts in the stores is recorded. Therefore, details of events can be changed according to the personal information, or details of services can be changed according to the number of privilege points.

According to the present invention, the managing unit reads personal information of a customer who visits the subordinate visitor-attracting facilities using the reader or reader/writer installed at least in each of the subordinate visitor-attracting facilities, and stores the personal information in a storage unit of the managing unit through the network.

The information of the customers who visit the stores is not only necessary for the stores, but also important for the entire shopping mall. For example, when which and how many customers enter or leave which store at what time is known, such information can be used for merchandise buying information, or utilized for analysis of the type of customers (the ages, the sex, and the like) coming to the stores.

According to the present invention, the managing unit customizes contents of a direct mail delivered to the customer based on records of usage at each of the subordinate visitor-attracting facilities.

To effectively utilize the direct mails, the direct mails to be delivered are preferably changed according to records of usage in each of the visitor-attracting facilities. Accordingly, information of the facilities that are frequently used by the customers can be efficiently transmitted.

According to the present invention, a temple/shrine shopping mall system that includes: a temple or shrine (or a church), stores, and a network connecting the temple or shrine (or a church) and the stores, and promotes visits of visitors to the temple or shrine, to the stores includes: Omamori-fudas, which are special talismans through to be imbued with power of gods or Buddha to protect holders, each including a recording medium that records information including personal information, a type of the Omamori-fuda, the number of points, and details of discounts when a product or service is provided by the stores, and an exterior package that contains the recording medium; an Omamori-fuda vending machine or Omikuji vending machine that is installed at the temple or shrine to vend the Omamori-fuda or an Omikuji and register the information in the recording medium; a reader or reader/writer that is installed in the stores to read the information recorded on the Omamori-fuda held by a customer who has received the product or service in the stores or write the information on the Omamori-fuda; and a management center that stores the information recorded on the Omamori-fuda, read by the reader or reader/writer through the network, in a database, and calculates a charge for the product based on the information, in which the management center includes: a determining unit that reads the information recorded on the Omamori-fuda using the reader or reader/writer to determine whether the number of points is recorded and whether the purchased product matches the type of the Omamori-fuda when purchased product information and price information is inputted by a POS system; and a calculating unit that calculates a discount rate and a charge for the product based on presence or absence of the number of points and presence or absence of the product matching the type of the Omamori-fuda, and the calculating unit increases the discount rate for the product when the determining unit determines that a required number of points is recorded and the purchased product matches the type of the Omamori-fuda, and calculates the charge for the product based on the number of points.

In the system according to the present invention, the temple or shrine is regarded as the principal visitor-attracting facility, and the stores are regarded as the subordinate visitor-attracting facilities. These facilities are connected by the network, and include the readers or readers/writers, respectively. The Omamori-fuda purchased at the temple or shrine includes the recording medium. The management center reads the number of privilege points recorded on the Omamori-fuda using the reader or reader/writer, and controls the reader or reader/writer to increase or decrease the read number of privilege points according to details of usage at the temple or shrine or in the stores.

According to the present invention, the Omamori-fuda vending machine includes: an input unit that inputs personal information of a customer who purchases the Omamori-fuda; a money inserting unit that inserts money for purchasing the Omamori-fuda; and a personal-information recording unit that records the personal information on the recording medium included in the Omamori-fuda.

A worshipper at the temple or shrine can utilize the system according to the present invention by purchasing an Omamori-fuda from the Omamori-fuda vending machine. That is, the Omamori-fuda is for example an IC card, and when personal information is inputted at the purchase and a required charge is inserted, the worshipper can possess an Omamori-fuda that is specific to the worshipper.

According to the present invention, the Omikuji vending machine includes: a display unit that displays how to operate the machine to purchase the Omikuji and a result of the Omikuji; a money inserting unit that inserts money for purchasing the Omikuji; an output unit that prints the result of the Omikuji and outputs the printed result; and an Omamori-fuda reader or reader/writer that reads the information recorded on the recording medium in the Omamori-fuda or writes the information on the recording medium.

The Omikuji vending machine according to the present invention needs the display unit that guides how to operate the machine to purchase the Omikuji. Because the Omikuji needs money to purchase, the Omikuji vending machine needs the money inserting unit that inserts money for purchasing the Omikuji, the output unit that prints a result of the Omikuji and outputs the printed result as a piece of paper, and the reader or reader/writer that records the number of points granted by purchase of the Omikuji on the Omamori-fuda.

According to the present invention, the Omikuji vending machine can select whether the result of the Omikuji is displayed by the display unit or the Omikuji is outputted by the output unit.

Some people want the result of the Omikuji not to be seen by others, and some people just want to know the result of the Omikuji and do not mind if others see it. In the former case, the Omikuji is printed and outputted by the output unit. In the latter case, the Omikuji is displayed by the display unit to show the result. The purchaser of the Omikuji can select one of these ways.

According to the present invention, the Omikuji vending machine transmits a result of the Omikuji to the management center through the network, and the management center calculates the number of points based on the received result of the Omikuji using the calculating unit to add the number to a current number of points, and transmits a result of the calculation to the Omikuji vending machine to record the result of the calculation on the Omamori-fuda using the Omamori-fuda reader or reader/writer.

The result of the Omikuji includes “Daikichi (great good fortune)”, “Chukichi (very good fortune)”, “Kichi (good fortune)”, “Kyo (bad luck)”, or the like. Originally, based on the result of the Omikuji, worshippers who have drawn “Kyo” places the Omikuji at the temple or shrine, and asks to perform rites (rituals performed in shrines to eliminate dangers and evils). According to the present invention, for example, a person who has drawn “Daikichi” is assumed to have won a lottery, and given services such as providing more points.

According to the present invention, when the Omikuji vending machine transmits the personal information read by the Omamori-fuda reader or reader/writer to the management center through the network, the calculating unit changes probabilities of appearance of results of the Omikuji according to the personal information recorded in the database.

Normally, the probabilities of appearance of the respective results of the Omikuji are balanced according to random digits. However, when the temple or shrine is considered to be an event facility, the probabilities of appearance of the respective results of the Omikuji can be changed according to the personal information recorded on the Omamori-fuda. For example, because the personal information includes the number of points, a higher probability of appearance of “Daikichi” can be set for customers having a large number of points.

According to the present invention, the temple/shrine shopping mall system includes a saisen-token vending machine including: a display unit that displays how to operate the machine to purchase a saisen token including a recording medium that records an amount of saisen that is offertory money; a money inserting unit that inserts money for purchasing the saisen token; an Omamori-fuda reader or reader/writer that reads the information recorded on the recording medium included in the Omamori-fuda or writes the information on the recording medium; and a saisen-amount recording unit that records the number of points corresponding to the amount of saisen on the recording medium in the Omamori-fuda, in which when the saisen token is purchased from the saisen-token vending machine, the amount of saisen inserted into the money inserting unit is transmitted to the management center through the network, and the management center calculates the number of points based on the received amount of saisen using the calculating unit, to add the number to a current number of points, and transmits a result of the calculation to the saisen-token vending machine to record the result of the calculation on the Omamori-fuda using the Omamori-fuda reader or reader/writer.

To give back the number of points in return for saisen thrown into the saisenbako, the unit that previously vends the saisen token is required. The reader or reader/writer that records the number of points corresponding to an amount of saisen on the Omamori-fuda at purchase of the saisen token is further required.

According to the present invention, the temple/shrine shopping mall system further includes: a saisen storage box in which money or the saisen token is thrown; and a saisen reader or reader/writer that reads the information recorded on the recording medium included in the Omamori-fuda or writes the information on the recording medium, in which the saisen reader or reader/writer includes: an input unit that inputs an amount of saisen; a display unit that display whether the number of points recorded on the recording medium included in the Omamori-fuda is sufficient; a sound emitter that emits a sound like one produced when saisen is thrown in the saisen storage box; and an antenna that reads information indicating a saisen token and being recorded on a recording medium included in the saisen token, and when offering of saisen is performed with the Omamori-fuda, the personal information recorded on the Omamori-fuda is read by the saisen reader or reader/writer, and when the number of points is recorded on the Omamori-fuda and an amount of saisen within the number of points is inputted by the input unit, the sound emitter emits the sound like one produced when saisen in thrown, and the number of points corresponding to the amount of inputted saisen is subtracted from a current number of points to update the number of points recorded on the recording medium in the Omamori-fuda.

The saisenbako according to the present invention includes the saisen reader or reader/writer that reads or writes details of records on the Omamori-fuda. When the offertory is performed with the points recorded on the Omamori-fuda, not with the actual money, the Omamori-fuda is brought close to the saisen reader or reader/writer, to check details of discounts or the number of points recorded on the recording medium in the Omamori-fuda using the display unit. When an amount of saisen within the checked number of points is inputted by the input unit, the sound emitter emits a sound like one produced when the saisen is thrown in the saisenbako. The number of points corresponding to the amount of inputted saisen is subtracted from the current number of points to update the number of points recorded on the recording medium in the Omamori-fuda.

According to the present invention, when offering of saisen is performed with the saisen token, the saisen token purchased from the saisen-token vending machine is thrown in the saisen storage box, to read the information indicating the saisen token using the antenna, and the sound emitter emits the sound like one produced when saisen is thrown.

According to the present invention, when the offertory is performed with a saisen token, the saisen token is thrown in the saisenbako, and information indicating the saisen token is read by the antenna. Accordingly, a sound like one produced when the saisen is thrown is emitted.

According to the present invention, when a customer purchases a product in the store and make settlement, the management center reads the information recorded on the recording medium in the Omamori-fuda using the reader or reader/writer at the settlement, and, when purchased product information and price information of the product is inputted by the POS system, and when the determining unit determines that a required number of points is recorded and that the purchased product matches the type of the Omamori-fuda, the calculating unit increases a discount rate for the product, subtracts the number of points corresponding to the discount rate, and newly adds the number of points corresponding to a charge for the purchased product.

When a worshipper has finished offering prayers at the temple or shrine and comes to the stores to purchase products in the stores, the Omamori-fuda is brought close to the reader or reader/writer at the settlement to read the number of points recorded on the recording medium. When the number of points is recorded, a predetermined amount is discounted from prices of the products according to the recorded number of points and the personal information. After the number of points corresponding to the discount rates is subtracted, the number of points corresponding to a charge for the purchased products is newly added.

According to the present invention, the management center causes the determining unit to determine the type of the Omamori-fuda, and causes the calculating unit to change the discount rate for the product to be purchased in the store according to the type of the Omamori-fuda determined by the determining unit, to calculate the charge for the product.

There are some kinds of Omamori-fudas wishing for traffic safety, academic achievements, safety and well-being of families, and being healthy, and the like. Therefore, when the kind of the Omamori-fuda used to purchase the product is known, and when the Omamori-fuda wishing for academic achievements is used for example, discounts for stationery are increased. When the Omamori-fuda wishing for health is used, foods and health appliances are mainly discounted.

According to the present invention, the management center causes the determining unit to determine a difference in the personal information of customers who hold the Omamori-fuda, and enables to change contents of the Omikuji based on a result of the determination.

The personal information of a customer includes for example the name, the birth date, the sex, the address, and the like. Therefore, some of the information is necessary or unnecessary depending on the personal information. For example, there is no need to inform male customers of the Omikuji results related to affairs specific to females such as childbirth.

According to the present invention, the management center causes the determining unit to determine a difference in the personal information of customers who hold the Omamori-fuda, to enable to change the details of the discounts or the number of points based on a result of the determination.

The school age can be determined from the birth data among the personal information. Accordingly, customers of ages for school entrance can be given services such as increasing a discount rate at purchase of stationery and the like even with the same number of points.

According to the present invention, the management center reads the personal information of a customer who visits the stores using the reader or reader/writer that is installed at least in each of the stores, and stores the personal information in a storage unit of the management center through the network.

The information of the customers who visit the stores is not only necessary for the stores, but also important for the entire temple or shrine shopping mall. For example, when which and how many customers enter or leave which store at what time is known, such information can be used for merchandise buying information, or utilized for analysis of the type of customers (the age, the sex, and the like) coming to the stores.

According to the present invention, the management center customizes contents of a direct mail delivered to the customer based on records of sales in each of the stores.

To effectively utilize the direct mails, the direct mails to be delivered are preferably changed according to records of usage in each of the stores. Accordingly, information of the stores that are frequently used by the customers can be efficiently transmitted.

According to the present invention, the temple or shrine is positioned to be visually confirmed by any of the stores.

The buildings of the temple/shrine shopping mall according to the present invention have such a configuration that the temple or shrine is constructed at a higher place to be seen from all stores, for example. Accordingly, features of the entire shopping mall can be seen at a glance.

### BRIEF DESCRIPTION OF THE DRAWINGS

FIG. 1 shows a configuration of a temple/shrine shopping mall system according to the present invention;

FIG. 2 shows an internal configuration of a management center according to the present invention;

FIG. 3 shows a configuration of a POS system installed in a store;

FIG. 4A is an example of details of record on an IC card included in an Omamori-fuda according to the present invention, and FIG. 4B shows a configuration of the Omamori-fuda;

FIG. 5 is an appearance diagram of an Omamori-fuda vending machine according to an embodiment of the present invention;

FIG. 6 is a flowchart for explaining an operation of the Omamori-fuda vending machine according to the embodiment;

FIG. 7 is an outline view of a saisenbako according to the embodiment;

FIG. 8 is a flowchart of a case that offertory is performed with the Omamori-fuda according to the present invention;

FIG. 9 is an appearance diagram of a saisen-token vending machine according to the embodiment;

FIG. 10 is a flowchart for explaining an operation of the saisen-token vending machine according to the embodiment;

FIG. 11 is a flowchart of a case that offertory is performed with a saisen token;

FIG. 12 is an appearance diagram of an Omikuji vending machine according to the embodiment;

FIG. 13 is a flowchart for explaining an operation of the Omikuji vending machine according to the embodiment; and

FIG. 14 is a flowchart for explaining an operation of a case that products are purchased and paid for in a store in the temple/shrine shopping mall system according to the present invention.

### DETAILED DESCRIPTION OF THE PREFERRED EMBODIMENTS

Embodiments of the present invention are explained in detail with reference to the drawings. Constituent elements described in the embodiments and types, combinations, shapes, and relative arrangements of the constituent elements or the like do not intend to limit the scope of the present invention, but are merely illustrative examples of the invention unless otherwise specified.

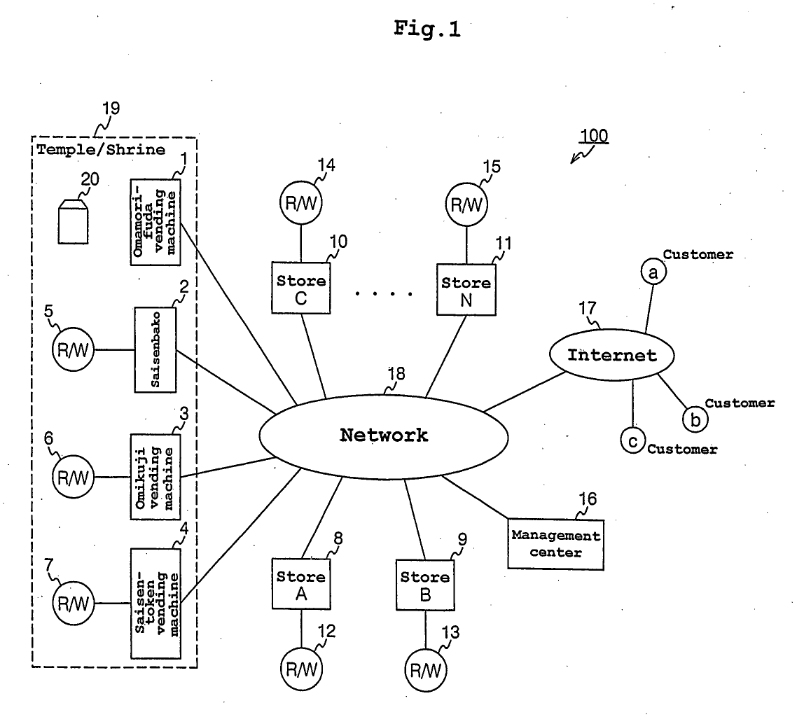

FIG. 1 shows a configuration of a temple/shrine shopping mall system according to an embodiment of the present invention. A temple/shrine shopping mall 100 includes a temple or shrine (including a church and other religious buildings) 19 as a principal visitor-attracting facility, plural stores 8 to 11 as subordinate visitor-attracting facilities, a management center 16 that manages the entire system, and a network 18 that connects these components. The Internet 17 is connected to the network 18, thereby enabling to receive or transmit information between plural customers “a” to “c”. The temple or shrine 19 includes Omamori-fudas 20 (which will be explained later in detail) each containing a recording medium for recording details of discounts or the number of points at reception of products or services in a store, an Omamori-fuda vending machine 1 (which will be explained later in detail) that is installed at the temple or shrine 19 to vend the Omamori-fudas 20 and registers the details of discounts or the number of points in the recording medium, an Omikuji vending machine 3 (which will be explained later in detail) that vends Omikujis and registers the details of discounts or the number of points in the recording medium, a saisenbako 2 (which will be explained later in detail) including a reader/writer 5, and a saisen-token vending machine 4 that vends saisen tokens.

The temple/shrine shopping mall system 100 further includes readers or readers/writers 12, 13, 14, and 15 (hereinafter, simply as readers/writers) that are installed in the stores, respectively, to read or write necessary information from or to the recording medium of an Omamori-fuda held by a customer who has received products or services in the store, and the management center 16 that manages the temple/shrine shopping mall system 100 based on the details of discounts or the number of points in the Omamori-fuda, read by each of the readers/writers through the network 18.

A schematic operation of the temple/shrine shopping mall system 100 is explained. Worshippers who offer prayers at the temple or shrine 19 purchases an Omamori-fuda 20 from the Omamori-fuda vending machine 1 to receive a privilege from the temple/shrine shopping mall system 100. The Omamori-fuda 20 includes a recording medium (which is explained as an IC card in the following descriptions), that records necessary information which is explained later. Another worshipper purchases a saisen token from the saisen-token vending machine 4, and throws the saisen token in the saisenbako 2. Another worshipper purchases an Omikuji from the Omikuji vending machine 3. The saisenbako 2, the Omikuji vending machine 3, and the saisen-token vending machine 4 includes readers/writers 5, 6, and 7, respectively. The worshipper who holds the Omamori-fuda brings the Omamori-fuda close to the reader/writer at each purchase of an Omikuji or saisen token to obtain the number of points. Accordingly, a predetermined number of points are recorded on the IC card, and necessary information recorded on the IC card is stored in a storage device of the management center 16 through the network 18.

When having completed offering prayers at the temple or shrine 9, the worshipper goes to an area in which the stores are collected, to enjoy shopping in the stores. Of course, some people just leave the place after offering prayers, however, when it is previously publicized that various privileges are granted in the use of the stores to worshippers who purchase the Omamori-fuda 20, many people can be led to the stores. Naturally, worshippers who do not purchase the Omamori-fuda 20 can also enjoy normal shopping in the stores. When the worshipper who holds the Omamori-fuda 20 makes a purchase in the store, he or she presents the Omamori-fuda 20 at the settlement, so that prices of products are discounted according to the number of points recorded on the Omamori-fuda 20. Of course, the number of points depending on the products are given at every purchase.

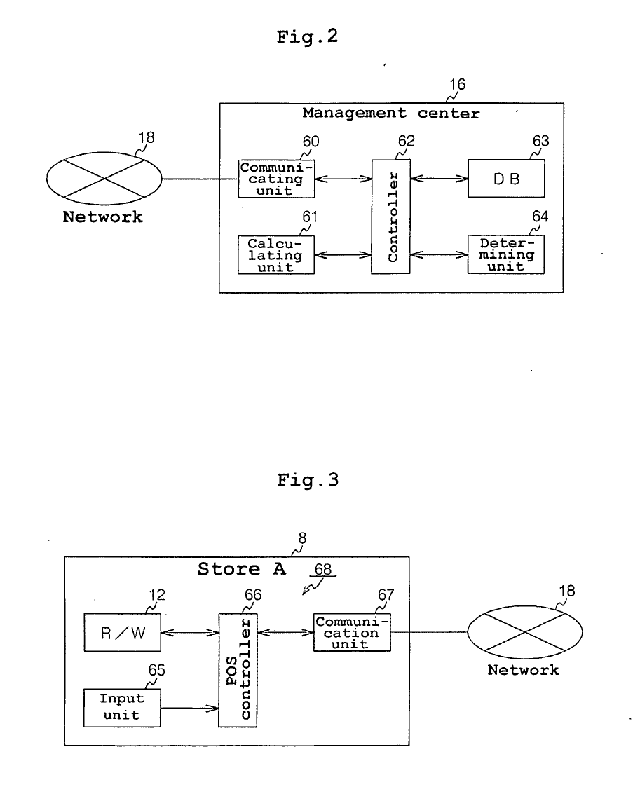

The management center 16 manages all of the information using a database (DB) 63 (in FIG. 2) in units of customers. Accordingly, it is possible to send information through the Internet 17 or send advertisements by direct mails to the respective customers, as required.

As described above, the temple/shrine shopping mall system 100 according to the present invention regards the temple or shrine 19 as the principal visitor-attracting facility and the stores 8 to 11 as the subordinate visitor-attracting facilities, and connects these facilities through the network 18. The facilities include the readers/writers 5 to 7 and 12 to 15, respectively. The Omamori-fuda 20 purchased at the temple or shrine 19 includes an IC card 21. The management center 16 reads the number of points recorded on the Omamori-fuda 20 by the corresponding reader/writer, and controls the reader/writer to increase or decrease the read number of points according to details of usage at the temple, shrine, or the stores.

FIG. 2 shows an internal configuration of the management center 16 according to the present invention. The management center 16 includes a DB 63 that stores information recorded on the Omamori-fuda 20, read by the reader/writer through the network 18, a determining unit 64 that reads the information recorded on the Omamori-fuda 20 by the reader/writer when information of purchased products and price information thereof is inputted by a POS system 68 (in FIG. 3), to determine whether the number points is recorded and whether the purchased products match the type of the Omamori-fuda 20, a calculating unit 61 that calculates discount rates and prices of the products based on the presence or absence of the number of points and the presence or absence of the product that accords with the type of the Omamori-fuda 20, a communicating unit 60 that transmits or receives information between the temple or shrine 19 and the respective stores 8 to 11 through the network 18, and a controller 62 that controls these components. The management center 16 is configured by a common computer, and controlled by programs (software) for operating respective functions of the components.

FIG. 3 shows a configuration of the POS system installed in a store A8. The POS systems installed in the respective stores have the same configuration. The POS system 68 includes a POS controller 66 that controls the system, an input unit 65 that inputs a product price or an operational instruction, a communication unit 67 that transmits or receives information to or from the management center 16 through the network 18, and a reader/writer 12 that is connected to the POS controller 66 to read or write information recorded on the Omamori-fuda 20. Thus, the POS system 68 is connected to the management center 16 by the communication unit 67 through the network 18, and reads or writes information of the Omamori-fuda 20 or the recording medium through the reader/writer 12 under the control of the management center 16.

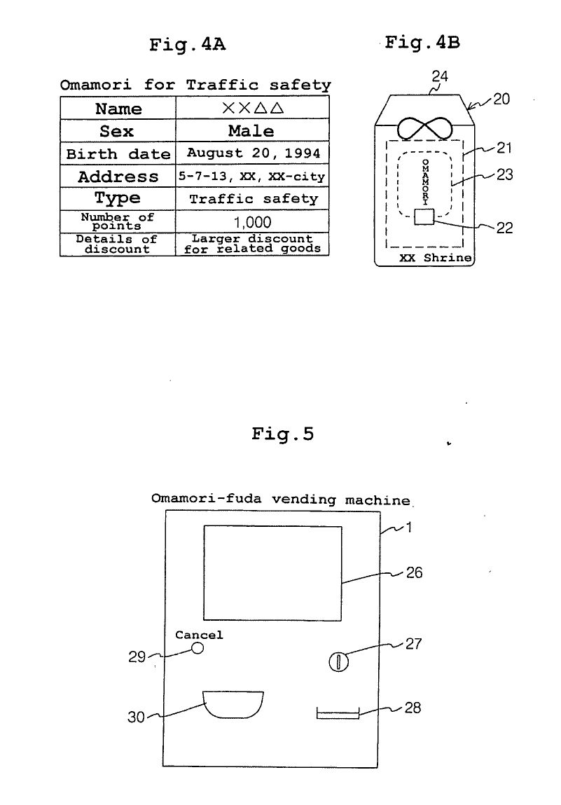

FIG. 4A is an example of details of recorded on the IC card 21 included in the Omamori-fuda 20 according to the present invention. FIG. 4B is an example of a specific configuration of the Omamori-fuda 20. On the IC card 21, data such as a name “XX**”, a sex “male”, a birth date “Aug. 20, 1944”, an address “5-7-13, XX, XX-city”, a type “traffic safety”, the number of points “1000”, and details of discount “larger discount for related goods” are recorded. Other data can be naturally recorded. The Omamori-fuda 20 shown in FIG. 4B is configured by an exterior package 24 on which “OMAMORI” in Japanese is written, and the IC card 21 as a recording medium that is contained in the exterior package 24 and records personal information of a worshipper who has purchased the Omamori-fuda 20. The IC card 21 is configured by an IC 22 including a control circuit and a storage device, an antenna 23, and a main body. The IC card 21 is a popularized noncontact IC card, and is driven by radio waves outputted from a reader/writer as a power supply. Therefore, because an operation of the IC card 21 is well known, the operation is not explained here. The noncontact IC card is used for the recording medium in the present embodiment, while a magnetic card, a contact IC card, or an IC tag can be used. When the type of the Omamori-fuda 20 (for example, one for wishing traffic safety, academic achievements, safety and well-being of families, or being healthy and the like), the number of points to be reflected to discounts in the stores and details of the discounts are recorded, in addition to the required minimum information of the name, the sex, the birth date, and the address, on the Omamori-fuda 20 as the personal information, details of an event can be changed according to the personal information, or details of services can be changed according to the number of points.

FIG. 5 is an appearance diagram of an Omamori-fuda vending machine according to an embodiment of the present invention. The Omamori-fuda vending machine 1 includes a touch panel (input unit) 26 for inputting personal information of a customer who purchases the Omamori-fuda 20, a coin slot 27 or a bill insertion slot 28 (money inserting unit) into which money for purchasing the Omamori-fuda 20 is inserted, a cancel button 29 for canceling purchase of the Omamori-fuda 20, an ejection slot 30 from which the Omamori-fuda 20 is issued or money to be returned is paid out, and a personal-information recording unit (not shown) that records the personal information on the IC card 21 included in the Omamori-fuda 20. The touch panel 26 also acts as a display unit that displays an operation procedure for inputting personal information of a customer at the purchase of the Omamori-fuda 20.

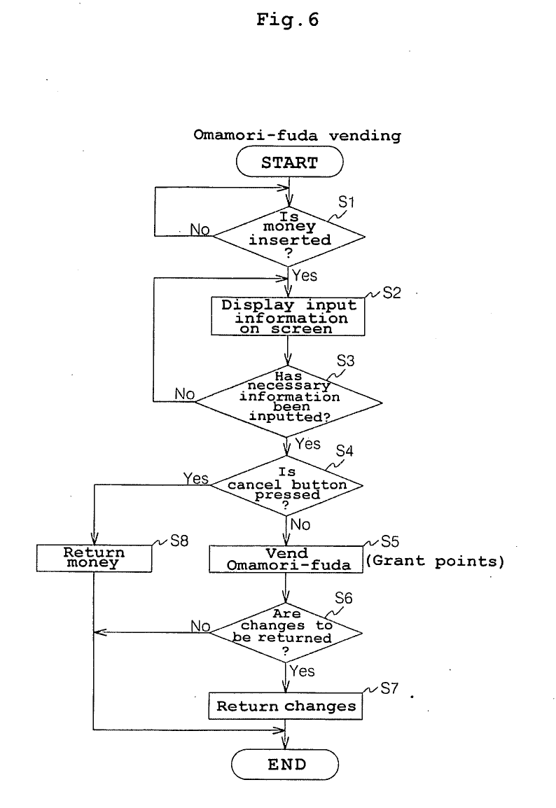

FIG. 6 is a flowchart for explaining an operation of the Omamori-fuda vending machine 1 according to the present embodiment. The operation is explained with referring also to FIG. 5. When money is inserted into the coin slot 27 or the bill insertion slot 28 of the Omamori-fuda vending machine 1 (YES at S1), guidance information such as “Input following information” is displayed on the touch panel 26 (S2). (The Omamori-fuda vending machine 1 can be connected to the management center 16 through the network 18 at this step, or can constantly remain online.) According to this instruction, a worshipper inputs the name, the sex, the birth date, the address, the type of an Omamori-fuda, and the like. The input information is stored in the DB 63 of the management center 16 through the network 18. When all the required information is inputted (YES at S3), the Omamori-fuda vending machine 1 checks whether the cancel button 29 is pressed (S4). When the cancel button 29 is pressed (YES at S4), all of the inserted money is returned to the ejection slot 30 (S8) to terminate the process, and the information stored in the DB 63 is deleted. When the cancel button 29 is not pressed at step S4 (NO at S4), the Omamori-fuda vending machine 1 records the necessary information (the name, sex, birth date, address, and type), the number of points, and details of discounts on the IC card 22 in the Omamori-fuda 20, and outputs the Omamori-fuda 20 to the ejection slot 30 (S5). When changes are to be returned (YES at S6), the changes are outputted to the ejection slot 30 (S7), and the process is terminated.

As described above, according to the present embodiment, the temple or shrine 19 can obtain votive offering of money (money to be donated to religious organizations, charities, community works, and the like) by selling the Omamori-fuda 20. Therefore, some services need to be given back to the worshippers who have purchased the Omamori-fuda 20. Thus, according to the present embodiment, basic points (for example, 1000 points) are granted to the worshipper who purchases the Omamori-fuda 20 for the first time at step S5, as services.

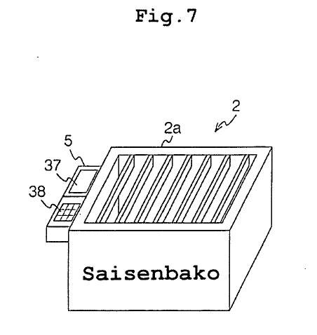

FIG. 7 is an outline view of a saisenbako according to the present embodiment. The saisenbako 2 includes a saisen storage box 2a in which money or a saisen token (that is explained later) is thrown, and a saisen reader/writer 5 that reads the information recorded on the IC card 21 included in the Omamori-fuda 20 or writes information on the IC card 21. The saisen reader/writer 5 includes a keyboard (input unit) 38 for inputting an amount of saisen, a panel (display unit) 37 that displays details of discounts recorded on the IC card 21 in the Omamori-fuda 20, or shortage or overage of the number of points, a sound emitter (not shown) that emits a sound like one produced when saisen is thrown in the saisen storage box 2a, and an antenna (not shown) that reads saisen amount information that is recorded on a recording medium included in the saisen token. Offertory to the saisenbako 2 can be performed by any of actual money, the saisen token, and the Omamori-fuda 20.

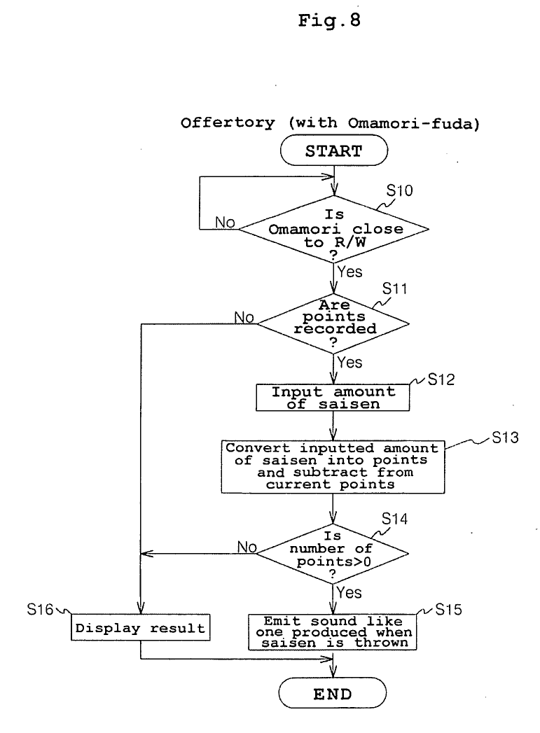

FIG. 8 is a flowchart of a case that offertory is performed with the Omamori-fuda 20. The saisenbako 2 constantly remains online. When the Omamori-fuda 20 is brought close to the saisen reader/writer 5 (YES at S10), the information recorded on the Omamori-fuda 20 is stored in the DB 63 of the management center 16 through the network 18. Details of discounts or the number of points recorded on the IC card 21 in the Omamori-fuda 20 are checked on the panel 37 (S11). An amount of saisen within the checked number of points is inputted by the keyboard 38 (S12). The inputted data are transmitted to the management center 16. The calculating unit 61 converts the inputted amount of saisen into the number of points, and subtracts the converted points from the current number of points (S13), to determine whether a result of the subtraction is positive (S14). When the result is positive (YES at S14), the reader/writer 5 is controlled so that the sound emitter emits a sound like one produced when saisen is thrown, and the result of the subtraction is written on the Omamori-fuda 20 (S15). When no point is recorded at step S11 or when the result of the subtraction is negative at step S14, the result is displayed on the panel 37 to terminate the process (S16).

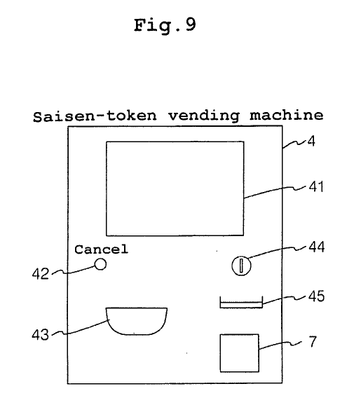

FIG. 9 is an appearance diagram of a saisen-token vending machine according to the present embodiment. A saisen-token vending machine 4 includes a touch panel (display unit) 41 that displays how to operate the machine to purchase a saisen token including a recording medium that records an amount of saisen, a coin slot 44 or a bill insertion slot 45 (money insertion unit) for inserting money to purchase the saisen token, an Omamori-fuda reader/writer 7 that reads information recorded on the IC card 21 included in the Omamori-fuda 20 or writes information on the IC card 21, a cancel button 42 for canceling purchase of the saisen token, an ejection slot 43 through which the saisen token or money to be returned is outputted, and a saisen-amount recording unit (not shown) that records an amount of saisen on an IC card 21 included in the saisen token.

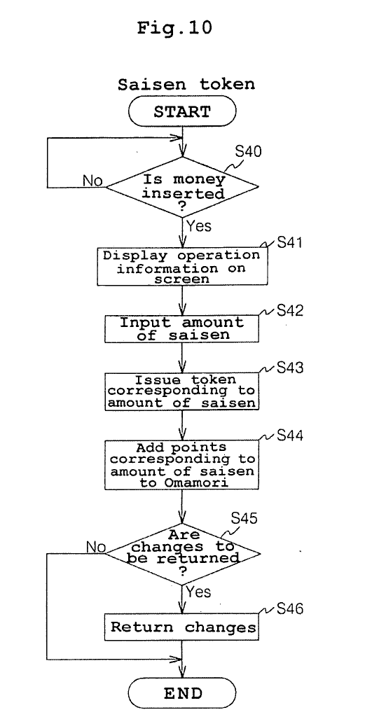

FIG. 10 is a flowchart for explaining an operation of the saisen-token vending machine 4 according to the present embodiment. The operation is explained with referring also to FIG. 9. The saisen-token vending machine 4 constantly remains online. When money is inserted into the coin slot 44 or the bill insertion slot 45 of the saisen-token vending machine 4 (YES at S40), guidance information such as “Set Omamori-fuda on Omamori-fuda reader/writer and Input saisen amount” is displayed on the touch panel 41 (S41). The worshipper sets the Omamori-fuda 20 on the Omamori-fuda reader/writer 7 according to the instruction, and inputs an amount of saisen (S42). Consequently, data of the amount of saisen and the information recorded on the Omamori-fuda 20 is stored in the DB 63 of the management center 16 through the network 18, and control is performed to issue a saisen token corresponding to the amount of saisen through the ejection slot 43 (S43). The saisen token corresponding to the amount of saisen has colors or sizes that differ according to the amount of money. Simultaneously, the number of points corresponding to the amount of saisen are added to the IC card 21 of the Omamori-fuda 20 (S44). When changes are to be returned (YES at S45), the changes are outputted through the ejection slot 43 (S46), and the process is terminated.

As described above, to give back the number of points in return for saisen thrown into the saisenbako 2, the saisen-token vending machine 4 vending a saisen token that records an mount of saisen is required independently of the saisenbako 2. Further, the Omamori-fuda reader/writer 7 is further required, which records the number of points corresponding to the amount of saisen on the Omamori-fuda 20 when a saisen token is purchased.

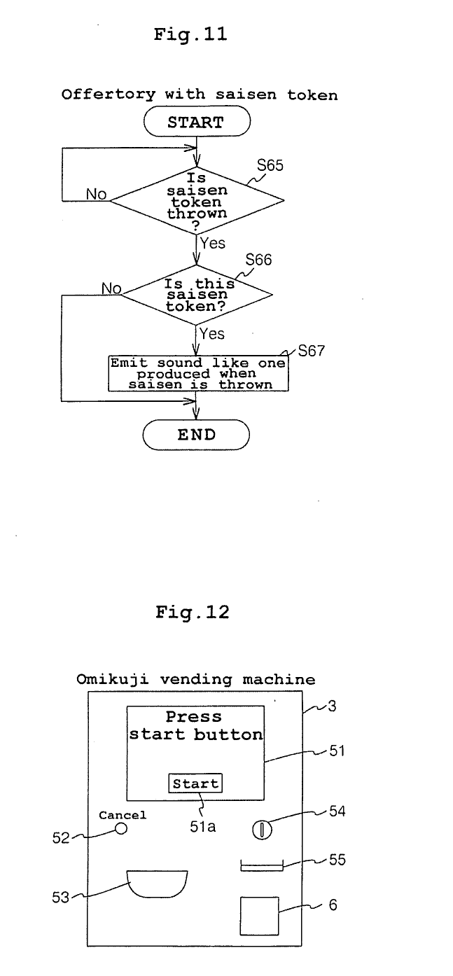

FIG. 11 is a flowchart of a case that offertory is performed with a saisen token. The saisenbako 2 initially checks whether a saisen token is thrown (S65). When a saisen token is thrown (YES at S65), information that is recorded on the saisen token to indicate that this is a saisen token is read (S66). When this is a saisen token, a sound like one produced when saisen is thrown is emitted (S67).

FIG. 12 is an appearance diagram of an Omikuji vending machine according to the present embodiment. The Omikuji vending machine 3 includes a touch panel (display unit) 51 that displays how to operate the machine to purchase an Omikuji and a result of the Omikuji, a coin slot 54 or a bill insertion slot 55 (money insertion unit) for inserting money to purchase an Omikuji, an ejection slot (output unit) 53 that outputs a printed result of the Omikuji, a cancel button 52 for canceling purchase of an Omikuji, and an Omamori-fuda reader/writer 6 that reads the information recorded on the IC card 21 in the Omamori-fuda 20 or writes information on the IC card 21.

The Omikuji vending machine 3 according to the present embodiment needs the touch panel 51 that guides how to operate the machine to purchase an Omikuji. Because the Omikuji needs money to purchase, the coin slot 54 or the bill insertion slot 55 for inserting money to purchase an Omikuji, the ejection slot (output unit) 53 that prints a result of the Omikuji on paper and outputs the paper, and the Omamori-fuda reader/writer 6 that records the number of points granted at purchase of the Omikuji, on the Omamori-fuda 20 are further required.

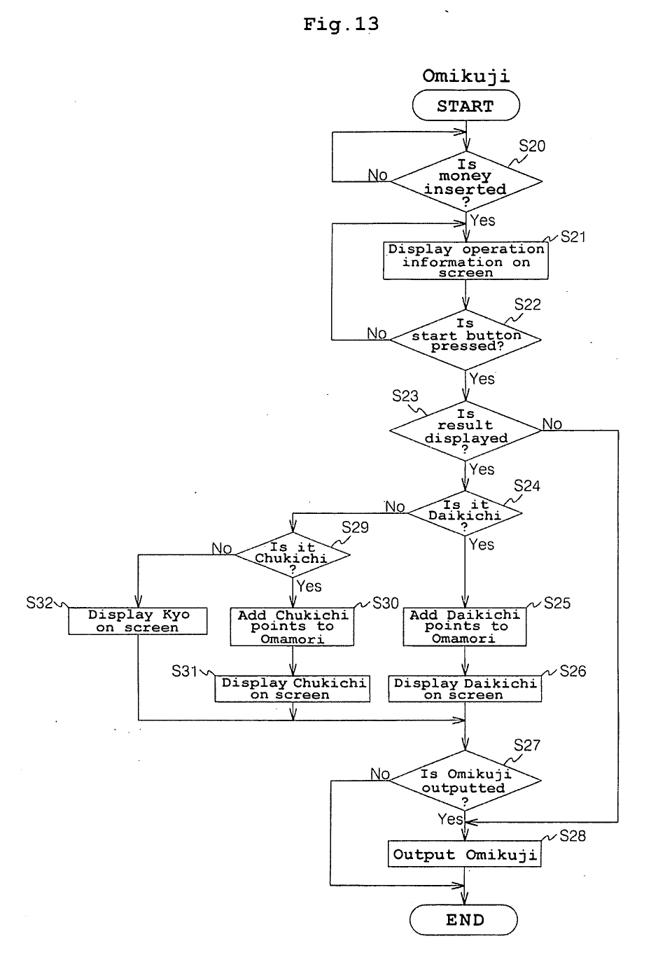

FIG. 13 is a flowchart for explaining an operation of the Omikuji vending machine 3 according to the present embodiment. The operation is explained with referring also to FIG. 12. The Omikuji vending machine 3 is constantly kept online. When money is inserted into the coin slot 54 or the bill insertion slot 55 of the Omikuji vending machine 3 (YES at S20), a start button 51a and guidance information indicating that “Set Omamori-fuda on Omamori-fuda reader/writer and Press start button” is for example displayed on the touch panel 51 (S21). When a worshipper sets the Omamori-fuda 20 on the Omamori-fuda reader/writer 6 and presses the start button 51a according to the instruction (YES at S22), “Display result of Omikuji? Press YES or NO. Select whether to output Omikuji when pressing YES. Output or Do not Output.” is displayed further on the touch panel 51. When the result is not to be displayed and “NO” is pressed, the process proceeds to step S28. The result is printed and outputted through the ejection slot (output unit) 53 (S28), and the process is terminated. When the result is to be displayed and “YES” is pressed at step S23 (YES at S23), an Omikuji is selected according to random digits, and the selected Omikuji is displayed. When the fortune written on the Omikuji is “Daikichi” (YES at S24), points corresponding to “Daikichi” are added to the Omamori-fuda 20 by the Omamori-fuda reader/writer 6 (S25), and “DAIKICHI (in Japanese)” is displayed on the touch panel 51 (S26). When the fortune written on the Omikuji is “Chukichi” (YES at S29), points corresponding to “Chukichi” are added to the Omamori-fuda 20 by the Omamori-fuda reader/writer 6 (S30), and “CHUKICHI (in Japanese)” is displayed on the touch panel 51 (S31). Otherwise, “KYO” is displayed on the touch panel 51 (S32). When “Output” is previously pressed (YES at step S27), the process proceeds to step S28. The result is printed and outputted through the ejection slot (output unit) 53 (S28), and the process is terminated.

Some people want the result of the Omikuji not to be seen by others, and some people just want to know the result of the Omikuji and do not mind if others see it. In the former case, the Omikuji is printed by the output unit and outputted through the ejection slot 53. In the latter case, the Omikuji is displayed on the touch panel 51 to be shown. Those who purchase the Omikuji can select one of these.

The fortunes on the Omikuji are classified into “Daikichi”, “Chukichi”, “Kichi”, “Kyo”, and the like. Originally, based on the result of the Omikuji, worshippers who have drawn “Kyo” place the Omikuji at the temple or shrine and ask rituals. According to the present invention, worshippers who have drawn “Daikichi” can be given services such as a larger number of points, assuming that the worshippers win lotteries. Normally, the probabilities of appearance of the respective results of the Omikuji are balanced according to random digits. However, when the temple or shrine is considered to be an event facility, the probabilities of appearance of the respective results of the Omikuji can be changed according to the personal information recorded on the Omamori-fuda 20. For example, because the personal information includes the number of points, a higher probability of appearance of “Daikichi” can be set for customers having a large number of points. The fortune on the Omikuji is limited only to the day of the purchase. Therefore, a time period during which the number of points obtained by the Omikuji are effective needs to be limited. Thus, according to the present invention, it is possible to manage the time of the personal information, and, when a predetermined time has elapsed, invalidate the discounts or the number of points changed by the Omikuji in the personal information. Such control is performed by controlling the Omikuji vending machine 3 through the network 18 by the management center 16. That is, one of “Daikichi”, “Chukichi”, “Kichi”, and “Kyo” is selected by referring to a random number table.

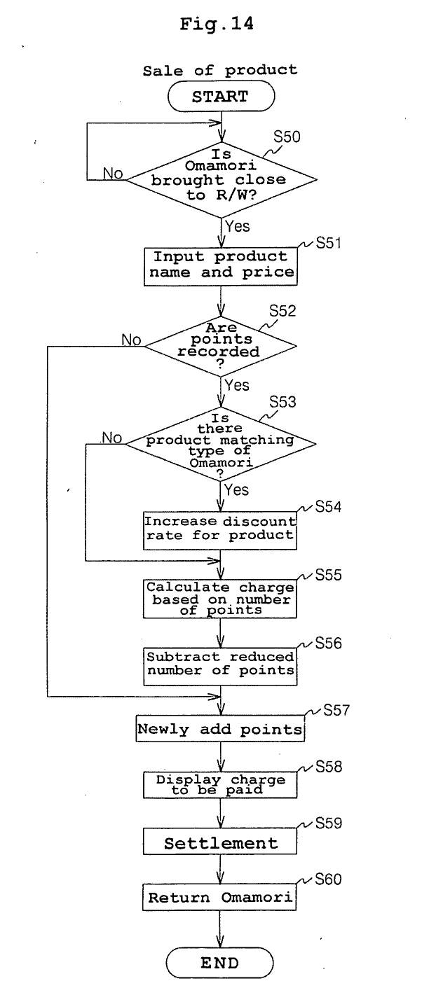

FIG. 14 is a flowchart for explaining an operation of a case that products are purchased in a store of the temple/shrine shopping mall system 100 according to the present invention and settlement is made. The POS system 68 in the store constantly remains online. A case of the store A8 is explained with reference to FIG. 3. When a worshipper who has finished offering prayers and purchased an Omamori does shopping in a store of the temple/shrine shopping mall system 100 and makes settlement, the worshipper presents products to be purchased and the Omamori-fuda 20 at a cashier. A sales clerk receives the products and the Omamori-fuda 20 and brings the Omamori-fuda 20 close to the reader/writer 12 (S50). Consequently, the information recorded on the Omamori-fuda 20 is transmitted to the management center 16 through the network 18 via the communication unit 67. The transmitted information is received by the communicating unit 60 of the management center 16 and stored in the DB 63. The sales clerk inputs the names and the prices of the purchased products through the input unit 65 (S51). The management center 16 reads the information of the customer from the DB 63, and checks whether the number of points is recorded on the IC card 21 in the Omamori-fuda 20 read by the reader/writer 12, using the determining unit 64 (S52). When no point is recorded, the process proceeds to step S57. The number of points corresponding to the prices of the purchased products are added to the IC card 21 (S57). When there are some points at step S52, it is determined whether the purchased products include any product matching the type of the Omamori-fuda 20 (S53). When any product matches, the discount rate for the product is increased (S54). When no product matches at step S53, a normal discount rate is applied and the process proceeds to step S55. The charge is calculated by the calculating unit 61 based on the number of points recorded on the IC card 21 of the Omamori-fuda 20 at step S55 (S55). The number of points corresponding to the reduced prices are subtracted (S56), and the number of points corresponding to the purchased products are newly added (S57). A result of this calculation is transmitted to the POS system 68 through the network 18, and recorded on the Omamori-fuda 20 by the reader/writer 12. The charge to be paid for is displayed at the cashier (S58). The sales clerk receives money from the customer to make settlement (S59), and returns the Omamori-fuda 20 to the customer (S60).

As described above, when a worshipper has finished offering prayers at the temple or shrine and comes to a store to purchase produces in the store, the Omamori-fuda 20 is brought close to the reader/writer 12 at the settlement, to read the number of points recorded on the IC card 21. When the number of points is recorded, a predetermined amount is discounted from the prices of the products according to the recorded number of points and the personal information. After the number of points corresponding to the discount rate are subtracted, the number of points corresponding to the prices of the purchased products are newly added. There are some kinds of the Omamori-fuda 20 wishing for traffic safety, academic achievements, safety and well-being of families, being healthy, and the like. Thus, the kind of the Omamori-fuda 20 used at the purchase of the products is checked. When the Omamori-fuda 20 wishing for academic achievements is used, discount for stationery is increased, for example. When the Omamori-fuda 20 wishing for being healthy is used, foods and health appliances are mainly discounted (which corresponds to S54). The information of the customers visiting the stores is not only necessary for the stores, but also important for the entire temple/shrine shopping mall 100. For example, when which and how many customers enter or leave which store at what time is known, this can be utilized for merchandise buying information, or used for analysis of the customers (the age, the sex, and the like). To utilize direct mails effectively, direct mails to be delivered are preferably changed according to usage records at each store. Accordingly, information of stores that are frequently used by the customers can be efficiently transmitted. As a configuration of the buildings of the temple/shrine shopping mall 100 according to the present embodiment, the temple or shrine is constructed at a higher place, for example, so that it can be seen from all the stores. Accordingly, features of the entire shopping mall can be seen at a glance.

As described above, according to the present invention, the principal visitor-attracting facility (temple or shrine) and the subordinate visitor-attracting facilities (stores) are connected by the network 18, and the facilities include the readers/writers, respectively. The management center 16 reads the number of points recorded on the IC card 21 using the reader/writer, to control the reader/writer to increase or decrease the read number of points according to details of usage in the respective visitor-attracting facilities. Therefore, the temple/shrine shopping mall system in which the event facility and the stores operate integrally can be provided.

When the recording medium is a magnetic card, a contact or noncontact IC card, or an IC tag, the information recorded on the recording medium can be processed as electronic data.

The management center 16 changes details of an event according to the personal information of the customer who holds the recording medium. Therefore, an optimum event depending on the customer can be provided.

The management center 16 changes the number of points according to the personal information of the customer who holds the recording medium. Accordingly, an optimum discount according to a product purchased by the customer can be provided.

The recording medium records at least the name, the sex, the birth date, the address, and the number of points of the customer. Thus, required minimum customer information can be obtained, and these data can be used to provide finely-tuned services according to each customer.

The management center 16 reads the personal information of customers who visit the store using the reader/writer that is installed at least in each store, and stores the personal information in the storage unit of the management center 16 through the network 18. Therefore, the management center 16 can create a database of the customers.

The management center 16 customizes contents of direct mails delivered to the customers according to the records of usage at each store. Accordingly, the contents of the direct mails can be optimized for each customer.

The management center 16 is connected to the network 18, calculates information to be recorded on the IC card 21 based on the information read by the respective reader/writer, and records the information through the reader/writer. Therefore, the information recorded on the IC card 21 can be updated in real time.

The Omamori-fuda vending machine 1 includes the touch panel 26 for inputting personal information of a customer who purchases the Omamori-fuda 20, the coin slot 27 or the bill insertion slot 28 for inserting money to purchase the Omamori-fuda 20, and the personal-information recording unit that records the personal information on the IC card 21 included in the Omamori-fuda 20. Therefore, the worshipper can possess the Omamori-fuda 20 that is specific to the worshipper.

On the Omamori-fuda 20, at least the name, the sex, the birth date, and the address of the customer, the type of the Omamori-fuda, and the number of points are recorded. Accordingly, these data can be used for obtaining required minimum customer information and providing finely-tuned services according to each customer.

The Omamori-fuda 20 is a magnetic card, a contact or noncontact IC card, or an IC tag. Therefore, information recorded on the recording medium can be processed as electronic data.

The Omamori-fuda vending machine 1 grants basic points to a customer who purchases the Omamori-fuda 20 for the first time. Accordingly, services in exchange for the votive offering of money can be given back to the worshippers.

The Omikuji vending machine 3 includes the touch panel 51 that displays how to operate the machine to purchase the Omikuji and a result of the Omikuji, the coin slot 54 or the bill insertion slot 55 for inserting money to be used to purchase the Omikuji, the ejection slot 53 that outputs a printed result of the Omikuji, and the Omamori-fuda reader/writer 6 that reads the information recorded on the IC card 21 included in the Omamori-fuda 20 or writes information on the IC card 21. Thus, the number of points can be added at each purchase of the Omikuji.

The Omikuji vending machine 3 can select whether a result of the Omikuji is displayed on the touch panel 51 or the Omikuji is outputted through the ejection slot 53. Therefore, a worshipper can voluntarily select how to see the Omikuji.

The Omikuji vending machine 3 changes details of discounts or the number of points based on the result of the Omikuji. Accordingly, the Omikuji can be reflected as a subject matter of the event.

The Omikuji vending machine 3 changes the probabilities of appearance of results of the Omikuji according to the personal information read by the Omamori-fuda reader/writer 6. Therefore, the probabilities of appearance of good fortunes on the Omikuji can be increased according to the number of points.

The management center 16 invalidates the discounts or the number of points in the personal information, which have been changed based on the result of the Omikuji, when a predetermined time has elapsed after the Omamori-fuda reader/writer 6 reads the personal information. Accordingly, the sales can be promoted by the number of points granted with the Omikuji.

When the saisen-token is purchased from the saisen-token vending machine 4, the management center 16 controls the Omamori-fuda reader/writer 7 to increase discounts or the number of points recorded on the IC card 21 included in the Omamori-fuda 20, according to the amount of thrown saisen. Therefore, the discounts or the number of points can be increased by offertory.

The saisenbako 2 includes the saisenbako reader/writer 5 that reads or writes records on the Omamori-fuda 20. When offertory is performed with the number of points recorded on the Omamori-fuda 20, not with actual money, the Omamori-fuda 20 is brought close to the saisenbako reader/writer 5. Details of discounts or the number of points recorded on the IC card 21 included in the Omamori-fuda 20 are checked on the panel 37, and an amount of saisen within the checked number of points is inputted by the keyboard 38. Accordingly, a sound like one produced when saisen is thrown is emitted by the sound emitter, and the number of points according to the amount of inputted saisen are subtracted from the current number of points, to update the number of points recorded on the IC card 21 in the Omamori-fuda 20. Thus, when the IC card 21 includes some points, offertory can be performed without actual money.

When the offertory is performed with a saisen token, the saisen token is thrown in the saisenbako 2, so that information indicating a saisen token is read by the antenna, and thus the sound like one produced when saisen is thrown is emitted. Accordingly, theft of saisen can be prevented, and a realistic sensation at the time of offering prayers can be provided.

When a worshipper has finished offering prayers at the temple or shrine and comes to a store to purchase products in the store, the Omamori-fuda 20 is brought close to the reader/writer at the settlement, to read the number of points recorded on the IC card 21. When the number of points is recorded, a predetermined amount is discounted from the prices of the products according to the recorded number of points and the personal information. At that time, the number of points according to the discount rate are subtracted, and the number of points according to the charge for the products are newly added. Thus, the number of points according to the current number of points and the charge for the products can be correctly recorded.

The management center 16 changes discount rates for the products to be purchased in the store according to the type of the Omamori-fuda 20. Therefore, service suited for demands of customers coming to the store can be provided.

The management center 16 can change contents of the Omikuji according to the personal information of customers who hold the Omamori-fuda 20. Therefore, only necessary information can be selectively provided.

The management center 16 can change details of discounts or the number of points according to the personal information of customers who hold the Omamori-fuda 20. Thus, details of discount can be differed according to the number of points.

The management center 16 reads the personal information of customers who visit each store by the reader/writer that is installed at least in each store, and stores the personal information in the storage unit of the management center 16 through the network 18. Therefore, a database of the customers can be created.

The management center 16 customizes contents of direct mails that are delivered to the customers based on records of sales at each store. Thus, the contents of the direct mails can be optimized for each customer.

The temple or shrine is positioned to be viewed by any of the stores. Therefore, features of the entire shopping mall can be seen at a glance.

According to the present invention, a principal visitor-attracting facility and subordinate visitor-attracting facilities are connected through a network, and the facilities have readers or readers/writers, respectively. A managing unit reads the number of privilege points recorded on a recording medium by the reader or the reader/writer, and controls the reader or reader/writer to increase or decrease the read number of privilege points according to details of usage in each of the facilities. Therefore, a shopping mall system in which an event facility and stores operate integrally can be provided.

According to the present invention, a magnetic card, a contact or noncontact IC card, or an IC tag is used for the recording medium. Accordingly, information recorded on the recording medium can be processed as electronic data.

According to the present invention, the managing unit changes details of an event according to personal information of customers who hold the recording medium. Therefore, an event most suitable for the customer can be provided.

According to the present invention, the managing unit changes the number of privilege points according to personal information of the customers who hold the recoding medium. Thus, an optimum discount depending on a product purchased by the customer can be provided.

According to the present invention, at least the name, the sex, the birth date, and the address of the client, and the number of privilege points are recorded on the recording medium. Therefore, these data can be used to obtain required minimum customer information and provide finely-tuned services according to the customers.

According to the present invention, the managing unit reads the personal information of customers who visit the subordinate visitor-attracting facilities using the reader or reader/writer installed at least in each of the subordinate visitor-attracting facilities, and stores the personal information in the storage unit of the managing unit through the network. Therefore, the managing unit can create a database of the customers.

According to the present invention, the managing unit customize contents of direct mails delivered to the customers based on records of usage at each of the subordinate visitor-attracting facilities. Therefore, the contents of the direct mails can be optimized for each customer.

According to the present invention, the principal visitor-attracting facility is a temple or shrine, and the subordinate visitor-attracting facilities are stores. These facilities are connected through a network and include readers or readers/writers, respectively, and the Omamori-fuda to be purchased at the temple or shrine includes a recording medium. Therefore, actions at the temple or shrine such as offertory and purchase of an Omikuji can be associated with details of usage in the store, so that the number of privilege points can be controlled.

According to the present invention, the Omamori-fuda vending machine includes an input unit that inputs personal information of a customer who purchases an Omamori-fuda, a money inserting unit that inserts money used to purchase the Omamori-fuda, and a personal-information recording unit that records personal information on a recording medium in the Omamori-fuda. Therefore, the worshipper can possess the Omamori-fuda that is specific to the worshipper.

According to the present invention, the Omikuji vending machine includes a display unit that displays how to operate the machine to purchase an Omikuji and a result of the Omikuji, a money inserting unit that inserts money used to purchase the Omikuji, an output unit that prints a result of the Omikuji and outputs the printed result, and an Omamori-fuda reader or reader/writer that reads information recorded on the recording medium in the Omamori-fuda or writes information on the recording medium. Therefore, the number of points can be added at each purchase of the Omikuji.

According to the present invention, the Omikuji vending machine can select whether the result of the Omikuji is displayed by the display unit or the Omikuji is outputted by the output unit. Thus, worshippers can voluntarily select how to see the Omikuji.

According to the present invention, the Omikuji vending machine changes details of discounts or the number of points based on the result of the Omikuji. Therefore, the Omikuji can be reflected as a subject matter of an event.

According to the present invention, the Omikuji vending machine changes the probabilities of appearance of results of the Omikuji according to the personal information read by the Omamori-fuda reader or reader/writer. Therefore, the probabilities of appearance of good fortunes on the Omikuji can be increased according to the number of points.

According to the present invention, a saisen-token vending machine is provided. When the saisen token is purchased from the saisen-token vending machine, the management center controls the Omamori-fuda reader or reader/writer to increase details of discounts or the number of points that are recorded on the recording medium in the Omamori-fuda, according to an amount of saisen inserted in the money inserting unit. Thus, the discounts or the number of points can be increased by the offertory.

According to the present invention, a saisenbako includes a saisenbako reader or reader/writer that reads or writes details of record on the Omamori-fuda. When the offertory is performed with the number of points recorded on the Omamori-fuda, not with actual money, the Omamori-fuda is brought close to the saisenbako reader or reader/writer. The details of discounts or the number of points recorded on the recording medium in the Omamori-fuda is checked on the display unit, and an amount of saisen within the checked number of points is inputted by the input unit. A sound like one produced when saisen is thrown is then emitted by the sound emitter, and the number of points corresponding to the inputted amount of saisen are subtracted from the current number of points, to update the number of points recorded on the recording medium in the Omamori-fuda. Thus, when the recording medium includes points, the offertory can be made without actual money.

According to the present invention, when the offertory is made with a saisen token, the saisen token is thrown in the saisenbako, and information indicating a saisen token is read by the antenna. A sound like one produced when saisen is thrown is then emitted, and thus theft of saisen can be prevented, and a realistic sensation at the time of offering prayers can be provided.

According to the present invention, when a worshipper has finished offering prayers at the temple or shrine and comes to a store to purchase products in the store, the worshipper brings the Omamori-fuda close to the reader or reader/writer at the settlement, to read the number of points recorded on the recording medium. When the number of points is recorded, a predetermined amount is discounted from the prices of the products according to the recorded number of points and the personal information. The number of points corresponding to the discount rate are subtracted, and the number of points corresponding to the charge for the purchased products are newly added. Therefore, the number of points according to the current number of points and the charge for the purchased products can be correctly recorded.

According to the present invention, the management center changes the discount rates for the products purchased in the store, according to the type of the Omamori-fuda. Accordingly, services suited to demands of the customer coming to the store can be provided.

According to the present invention, the management center can change contents of the Omikuji according to the personal information of customers who hold the Omamori-fuda. Therefore, only necessary information can be selectively provided.

According to the present invention, the management center can change the details of discounts or the number of points according to the personal information of customers who hold the Omamori-fuda. Thus, the discounts can be differed according to the number of points.

According to the present invention, the management center reads the personal information of customers who visit the stores using the reader or reader/writer installed at least in each of the stores, and stores the personal information in the storage unit of the management center through the network. Therefore, a database of the customers can be created.

According to the present invention, the management center customizes contents of direct mails delivered to the customers based on records of sales in each store. Therefore, the contents of the direct mails can be optimized for each of the customers.

According to the present invention, the temple or shrine is positioned to be seen from any of the stores. Therefore, features of the entire shopping mall can be seen at a glance.

1. A shopping mall system that includes a principal visitor-attracting facility, subordinate visitor-attracting facilities, and a network that connects both of the principal and subordinate visitor-attracting facilities, and promotes visits of visitors to the principal visitor-attracting facility, to the subordinate visitor-attracting facilities,
the shopping mall system including: a recording medium that records privileges granted to a customer who uses each of the visitor-attracting facilities; a register that registers the number of privilege points in the recording medium based on details of an event implemented in the principal visitor-attracting facility; a reader or reader/writer that is installed at least in either the principal visitor-attracting facility or the subordinate visitor-attracting facilities, to read or write necessary information from or on the recording medium held by a user of the visitor-attracting facility; and a managing unit that manages the shopping mall system based on the number of privilege points on the recording medium, read by the reader or reader/writer through the network, wherein
the managing unit includes: a determining unit that reads the information recorded on the recording medium using the reader or reader/writer when information of a purchased product and price information of the product is inputted by a POS system, to determine whether the number of privilege points is recorded and whether the purchased product matches a type of the recording medium; and a calculating unit that calculates a discount rate and a charge for the product based on presence or absence of the number of privilege points and presence or absence of the product matching the type of the recording medium, and when the determining unit determines that required number of privilege points is recorded and that the purchased product matches the type of the recording medium, the calculating unit increases the discount rate for the corresponding product and calculates the charge according to the number of the privilege points.

2. The shopping mall system according to claim 1, wherein the recording medium is one of a magnetic card, a contact or noncontact IC card, and an IC tag.

3. The shopping mall system according to claim 1, wherein when personal information recorded on the recording medium is read by the reader or reader/writer and transmitted to the managing unit through the network, the calculating unit changes the details of the event according to the personal information recorded in a database of the managing unit.

4. The shopping mall system according to claim 1, wherein when personal information recorded on the recording medium is read by the reader or reader/writer and transmitted to the managing unit through the network, the calculating unit changes the number of privilege points according to the personal information recorded in a database of the managing unit.

5. The shopping mall system according to any one of claims 1 to 4, wherein at least a name, a sex, a birth date, and an address of a customer, the type of the recording medium, the number of privilege points, and details of discounts are recorded on the recording medium.

6. The shopping mall system according to any one of claims 1, 3, and 4, wherein the managing unit reads personal information of a customer who visits the subordinate visitor-attracting facilities using the reader or reader/writer installed at least in each of the subordinate visitor-attracting facilities, and stores the personal information in a storage unit of the managing unit through the network.

7. The shopping mall system according to claim 1, wherein the managing unit customizes contents of a direct mail delivered to the customer based on records of usage at each of the subordinate visitor-attracting facilities.

8. A temple/shrine shopping mall system that includes: a temple or shrine, stores, and a network connecting the temple or shrine and the stores, and promotes visits of visitors to the temple or shrine, to the stores,
the temple/shrine shopping mall system including: Omamori-fudas, which are special talismans through to be imbued with power of gods or Buddha to protect holders, each including a recording medium that records information including personal information, a type of the Omamori-fuda, the number of points, and details of discounts when a product or service is provided by the stores, and an exterior package that contains the recording medium; an Omamori-fuda vending machine or Omikuji vending machine that is installed at the temple or shrine to vend the Omamori-fuda or an Omikuji and register the information in the recording medium; a reader or reader/writer that is installed in the stores to read the information recorded on the Omamori-fuda held by a customer who has received the product or service in the stores or write the information on the Omamori-fuda; and a management center that stores the information recorded on the Omamori-fuda, read by the reader or reader/writer through the network, in a database, and calculates a charge for the product based on the information, wherein
the management center includes: a determining unit that reads the information recorded on the Omamori-fuda using the reader or reader/writer to determine whether the number of points is recorded and whether the purchased products matches the type of the Omamori-fuda when purchased product information and price information is inputted by a POS system; and a calculating unit that calculates a discount rate and a charge for the product based on presence or absence of the number of points and presence or absence of the product matching the type of the Omamori-fuda, and
the calculating unit increases the discount rate for the product when the determining unit determines that a required number of points is recorded and the purchased product matches the type of the Omamori-fuda, and calculates the charge for the product based on the number of points.

9. The temple/shrine shopping mall system according to claim 8, wherein the Omamori-fuda vending machine includes: an input unit that inputs personal information of a customer who purchases the Omamori-fuda; a money inserting unit that inserts money for purchasing the Omamori-fuda; and a personal-information recording unit that records the personal information on the recording medium included in the Omamori-fuda.

10. The temple/shrine shopping mall system according to claim 8, wherein the Omikuji vending machine includes: a display unit that displays how to operate the machine to purchase the Omikuji and a result of the Omikuji; a money inserting unit that inserts money for purchasing the Omikuji; an output unit that prints the result of the Omikuji and outputs the printed result; and an Omamori-fuda reader or reader/writer that reads the information recorded on the recording medium in the Omamori-fuda or writes the information on the recording medium.

11. The temple/shrine shopping mall system according to claim 10, wherein the Omikuji vending machine can select whether the result of the Omikuji is displayed by the display unit or the Omikuji is outputted by the output unit.

12. The temple/shrine shopping mall system according to any one of claims 8, 10, and 11, wherein the Omikuji vending machine transmits a result of the Omikuji to the management center through the network, and the management center calculates the number of points based on the received result of the Omikuji using the calculating unit to add the number to a current number of points, and transmits a result of the calculation to the Omikuji vending machine to record the result of the calculation on the Omamori-fuda using the Omamori-fuda reader or reader/writer.

13. The temple/shrine shopping mall system according to claim 8, wherein when the Omikuji vending machine transmits the personal information read by the Omamori-fuda reader or reader/writer to the management center through the network, the calculating unit changes probabilities of appearance of results of the Omikuji according to the personal information recorded in the database.

14. The temple/shrine shopping mall system according to claim 8, including a saisen-token vending machine including: a display unit that displays how to operate the machine to purchase a saisen token including a recording medium that records an amount of saisen that is offertory money; a money inserting unit that inserts money for purchasing the saisen token; an Omamori-fuda reader or reader/writer that reads the information recorded on the recording medium included in the Omamori-fuda or writes the information on the recording medium; and a saisen-amount recording unit that records the number of points corresponding to the amount of saisen on the recording medium in the Omamori-fuda, wherein
when the saisen token is purchased from the saisen-token vending machine, the amount of saisen inserted into the money inserting unit is transmitted to the management center through the network, and the management center calculates the number of points based on the received amount of saisen using the calculating unit, to add the number to a current number of points, and transmits a result of the calculation to the saisen-token vending machine to record the result of the calculation on the Omamori-fuda using the Omamori-fuda reader or reader/writer.

15. The temple/shrine shopping mall system according to claim 14, further including: a saisen storage box in which money or the saisen token is thrown; and a saisen reader or reader/writer that reads the information recorded on the recording medium included in the Omamori-fuda or writes the information on the recording medium, wherein
the saisen reader or reader/writer includes: an input unit that inputs an amount of saisen; a display unit that display whether the number of points recorded on the recording medium included in the Omamori-fuda is sufficient; a sound emitter that emits a sound like one produced when saisen is thrown in the saisen storage box; and an antenna that reads information indicating a saisen token and being recorded on a recording medium included in the saisen token, and
when offering of saisen is performed with the Omamori-fuda, the personal information recorded on the Omamori-fuda is read by the saisen reader or reader/writer, and when the number of points is recorded on the Omamori-fuda and an amount of saisen within the number of points is inputted by the input unit, the sound emitter emits the sound like one produced when saisen in thrown, and the number of points corresponding to the amount of inputted saisen is subtracted from a current number of points to update the number of points recorded on the recording medium in the Omamori-fuda.

16. The temple/shrine shopping mall system according to claim 14, wherein when offering of saisen is performed with the saisen token, the saisen token purchased from the saisen-token vending machine is thrown in the saisen storage box, to read the information indicating the saisen token using the antenna, and the sound emitter emits the sound like one produced when saisen is thrown.

17. The temple/shrine shopping mall system according to claim 8, wherein when a customer purchases a product in the store and make settlement, the management center reads the information recorded on the recording medium in the Omamori-fuda using the reader or reader/writer at the settlement, and, when purchased product information and price information of the product is inputted by the POS system, and when the determining unit determines that a required number of points is recorded and that the purchased product matches the type of the Omamori-fuda, the calculating unit increases a discount rate for the product, subtracts the number of points corresponding to the discount rate, and newly adds the number of points corresponding to a charge for the purchased product.

18. The temple/shrine shopping mall system according to claim 8, wherein the management center causes the determining unit to determine the type of the Omamori-fuda, and causes the calculating unit to change the discount rate for the product to be purchased in the store according to the type of the Omamori-fuda determined by the determining unit to calculate the charge for the product.

19. The temple/shrine shopping mall system according to claim 8, wherein the management center causes the determining unit to determine a difference in the personal information of customers who hold the Omamori-fuda, and enables to change contents of the Omikuji based on a result of the determination.

20. The temple/shrine shopping mall system according to claim 8, wherein the management center causes the determining unit to determine a difference in the personal information of customers who hold the Omamori-fuda, to enable to change the details of the discounts or the number of points based on a result of the determination.

21. The temple/shrine shopping mall system according to any one of claims 8, 17, 18, 19, and 20, wherein the management center reads the personal information of a customer who visits the stores using the reader or reader/writer that is installed at least in each of the stores, and stores the personal information in a storage unit of the management center through the network.

22. The temple/shrine shopping mall system according to claim 8, wherein the management center customizes contents of a direct mail delivered to the customer based on records of sales in each of the stores.

23. The temple/shrine shopping mall system according to claim 8, wherein the temple or shrine is positioned to be visually confirmed by any of the stores.
